(19) United States
(12) Patent Application Publication
(10) Pub. No.: US 2008/0255973 A1
(43) Pub. Date: Oct. 16, 2008

(54) Sales transaction analysis tool and associated method of use

(76) Inventors: Robert El Wade, Flower Mound, TX (US); Victor Cisneros Garcia, Huizachal (MX); Bernhard Matthias Herzog, Oberursel (DE); Anne Christine Zumsteg, Mountainside, NJ (US)

Correspondence Address: M. Susan SPIERING;c/o Celanese Ltd., IP Legal Dept., IZIP 701, 400 HWY 77S / PO BOX 428, BISHOP, TX, 78343, US

(21) Appl. No.: 11/784,785

(22) Filed: Apr. 10, 2007

(51) Int. Cl. G06Q 40/00

(52) U.S. Cl. 705/35

(57) ABSTRACT

A computer implemented sales transaction tool and associated method of use is disclosed. This includes at least one processor configured to receive sales transaction information and programmed to provide the following functionality: a series of control functions that can be selectively activated by input to the processor for creating at least one subset of the sales transaction information, a plurality of graphical representations that are generated based on the selected subset of sales transaction information, and displaying at least one graphical representation of the plurality of graphical representations on an electronic display associated with the processor. Graphical representations of sales transaction information may include a slope and scatter diagram of sales transaction information, a waterfall chart, waterfall transactional analysis, a time series chart, a price sensor, a margin sensor, a break-even analysis graph and a bubble chart. There are graphical representations to evaluate opportunity of moving low margin products to average margins of comparable products and determining value for products having a single customer.

### BACKGROUND OF INVENTION

A major problem facing all businesses today is the ability to be able to identify the value derived from each customer. There is a interdependence between volume and margin and most organizations have a difficult time determining how a change in volume can affect the margin until after the fact and numerous sales have been made at a particular price. This creates a tremendous problem since it is very difficult for an organization to stay profitable in a dynamically changing sales environment. Moreover, once a lower price has been offered to a customer, a course correction to obtain a reasonable margin is very difficult without losing the customer altogether. Another major issue is being able to analyze the enormous volume and complexity of price and cost elements and being able to relate this information back to the individual sales order. It is very difficult to maintain profitability if the individual components that contribute to the final transaction price are not known.

An important function of operating a business is being able to ascertain an individual customer's contribution to price changes and estimate the theoretical impact of a price change on the sales volume. It is also important to be able to identify cost and margin drivers associated with sales transactions. Another important issue is low margin products and whether it is possible to move the price of these products upward so that these products enjoy at least an average pocket margin of comparable products in a selected peer group. Another important issue is the process of providing an exclusive product to a single customer and determining whether the return on these sales makes sense from a business perspective. A major problem is the ability to dynamically ascertain the relationship between sales volume, margin, revenue and a particular customer or predetermined group of customers. There is a significant need to be able to determine what prices need to be raised, along with a projected loss of volume, in order to obtain a desired range of margin. Another issue is the ability to be able to ascertain the plant gate pocket price, which is the gross sales price minus all cost elements, with the exception of raw material costs, in relationship to cumulative quantity.

Although there are tools to analyze profit such as the PROFIT ANALYZER™ manufactured by Vendavo, Inc., having a place of business at 1029 Corporation Way, Palo Alto, Calif. 94303, these tools seem to lack the ability to collectively look at the elements forming the price in a side-by-side comparison.

The present invention is directed to overcoming one or more of the problems set forth above.

### SUMMARY OF INVENTION

In an aspect of this invention, a sales transaction tool is disclosed. This sales transaction tool includes at least one processor, such as a computer and/or data processor, that receives sales transaction information, a series of control functions that can be selectively activated by input to the at least one processor for creating at least one subset of the sales transaction information, a plurality of graphical representations that are generated based on the selected subset of sales transaction information, and at least one electronic display for displaying at least one graphical representation of the plurality of graphical representations.

In another aspect of this invention, a sales transaction tool is disclosed. This sales transaction tool includes at least one processor that receives sales transaction information, a series of control functions that can be selectively activated by input to the at least one processor for creating at least one subset of the sales transaction information, wherein the series of control functions includes at least one of a product-type control, a time period-type control, a predetermined grouping of customers, a predetermined market, and a plurality of graphical representations that are generated based on the selected subset of sales transaction information, wherein the plurality of graphical representations includes at least one of a graphical representation of gross sales price information minus predetermined cost elements versus quantity, a slope and scatter diagram of sales transaction information, a price and margin solver, a time series chart, a price sensor, a margin sensor and a break-even analysis graph, waterfall analysis of sales transaction information, a low volume analysis tool for estimating opportunity of moving low margin products to average margins of comparable products, a single customer analysis tool for determining value with a single customer, and a transactional waterfall bubble chart, and at least one electronic display for displaying at least one graphical representation of the plurality of graphical representations.

In still another aspect of this invention, a method for utilizing a sales transaction tool is disclosed. The method includes receiving sales transaction information with at least one processor, selectively activating a series of control functions by input to the at least one processor for creating at least one subset of the sales transaction information, generating a plurality of graphical representations based on the at least one selected subset of sales transaction information, and displaying at least one graphical representation of the plurality of graphical representations on at least one electronic display.

In still another aspect of this invention, a method for utilizing a sales transaction tool is disclosed. The method includes receiving sales transaction information with at least one processor, selectively activating a series of control functions by input to the at least one processor for creating at least one subset of the sales transaction information, wherein the series of control functions includes at least one of a product-type control, a time period-type control, a predetermined grouping of customers, and a predetermined market, generating a plurality of graphical representations based on the at least one selected subset of sales transaction information, wherein the plurality of graphical representations includes at least one of a graphical representation of gross sales price information minus predetermined cost elements versus quantity, a slope and scatter diagram of sales transaction information, a price and margin solver, a time series chart, a price sensor, a margin sensor and a break-even analysis graph, waterfall analysis of sales transaction information, a low volume analysis tool for estimating opportunity of moving low margin products to average margins of comparable products, a single customer analysis tool for determining value with a single customer, and a transactional waterfall bubble chart, and displaying at least one graphical representation of the plurality of graphical representations on at least one electronic display.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 illustrates an exemplary screen display (graphical user interface) of the present invention showing a main front page viewed by a user for performing fishtail analysis and for generating a slope and scatter chart utilizing controls to selectively acquire data;

FIG. 2 illustrates an exemplary display (graphical user interface) for selecting and disabling various sales transaction analysis tools associated with the present invention;

FIG. 3 illustrates an exemplary display (graphical user interface) for managing data files and acquiring information regarding the system associated with the present invention;

FIG. 4 illustrates graphical information available through the slope and scatter chart illustrated in FIG. 1 and associated with the present invention;

FIG. 5 illustrates an exemplary display (graphical user interface) for generating a time series chart, break-even analysis and price and/or margin sensors associated with the present invention;

FIG. 6 illustrates an exemplary display (graphical user interface) displaying associated subfunctions available with the price and/or margin sensors shown in FIG. 5 and associated with the present invention;

FIG. 7 illustrates an exemplary display (graphical user interface) for generating fishtail analysis and associated histograms associated with the present invention;

FIG. 8 illustrates an exemplary display (graphical user interface) for generating a transactional waterfall aggregate browser associated with the present invention;

FIG. 9 illustrates an exemplary display (graphical user interface) for generating low volume analysis including tables and graphical representations associated with the present invention;

FIG. 10 illustrates an exemplary graphical display of low volume product analysis of annual sales versus a particular product identification, e.g., stock keeping unit (“SKU”), in predetermined time units, e.g., quarters, associated with the present invention;

FIG. 11 illustrates an exemplary display (graphical user interface) for generating single customer analysis including tables and graphical representations associated with the present invention; and

FIG. 12 illustrates an exemplary display (graphical user interface) for generating a transactional waterfall bubble chart including graphical representations associated with the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. For example, the invention is not limited in scope to the particular type of industry application depicted in the figures, a particular type of software language, or to particular conventions regarding software designations. In other instances, well-known methods, procedures and components have not been described in detail so as not to obscure the present invention. A processor referred to in this Application can be a single processor or a whole series of processors. An illustrative, but nonlimiting, application for this technology includes the chemical industry. An illustrative, but nonlimiting source of the data/information from custom built multi-cube information from SAP® via the Business Warehouse™ system. SAP® is a federally registered trademark of SAP America, Inc., having a place of business at 3999 West Chester Pike, Newtown Square, Pa. 19073. An illustrative, but nonlimiting, mechanism for receiving data and performing computations can include EXCEL®. EXCEL® is a federally registered trademark of Microsoft Corporation, having a place of business at One Microsoft Way, Redmond, Wash. 980526399.

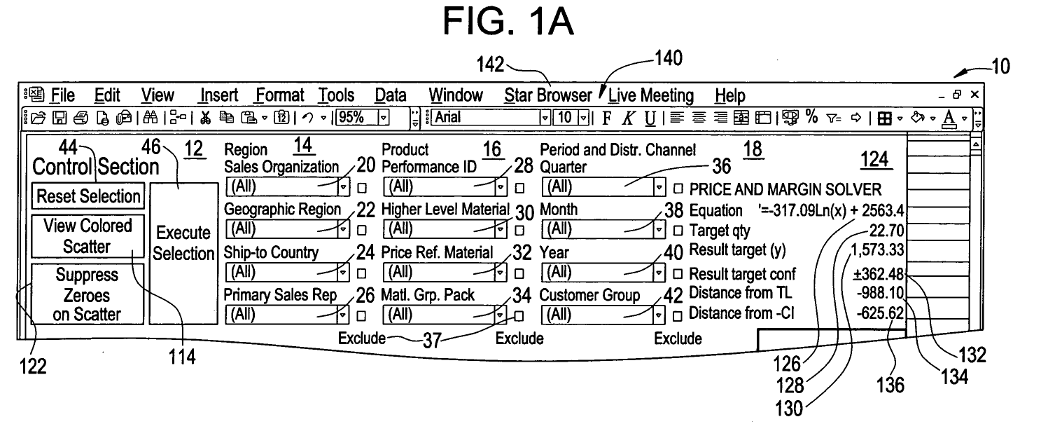

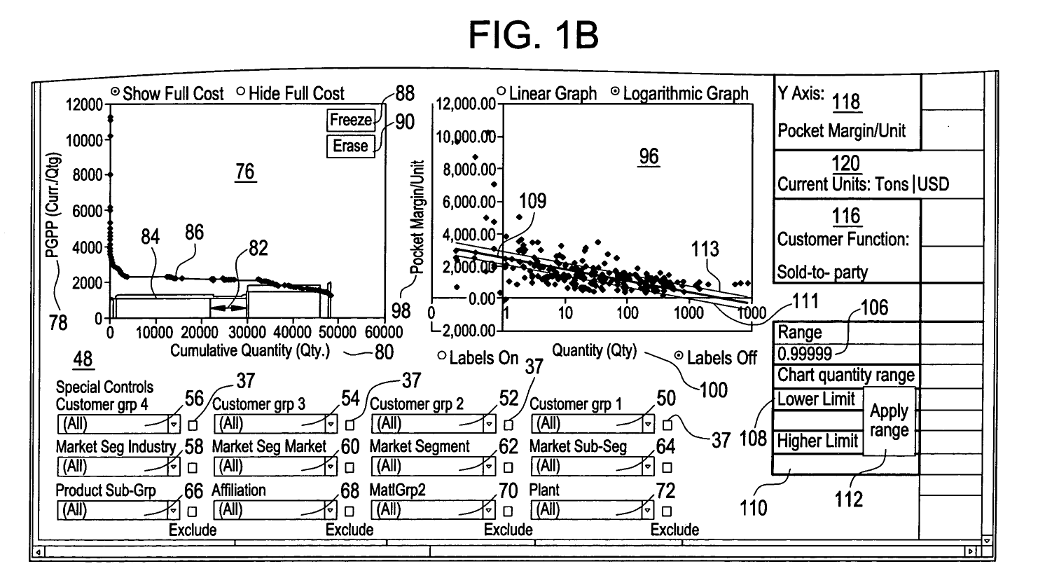

Referring now to the drawings, initially to FIG. 1, where FIG. 1 is a sample screen display of a main graphical user interface, which is indicated by numeral 10. This screen display 10 is reached after going through login security. Illustrative, but nonlimiting, examples of login security may include activation of macros, provision of a password and/or userid followed by verification of the password, the userid, and/or the computer domain.

There is a control section that is generally indicated by numeral 12. The first section in the control section 12 is for selecting a particular sales region. Under the heading of “region” 14, there are several inputs that the user can utilize to select sales transaction data associated with a sales information. Illustrative, but nonlimiting examples include: a drop-down input 20 to select a predetermined sales organization; a drop-drop down input 22 to select a predetermined geographic region; a drop-drop down input 24 to select a predetermined country to which the product will be shipped; and a drop-down input 26 to provide a predetermined primary sales representative.

A second section in the control section 12 is for selecting a particular product. Under the heading of “product” 16, there are several inputs that the user can utilize to select sales transaction data associated with product information. Illustrative, but nonlimiting examples include: a drop-down input 28 to select a predetermined product, e.g., product performance identification; a drop-drop down input 30 to select a predetermined subtype or subcomponent of product, e.g., higher level material; and a drop-down input 32 to provide a predetermined different version or category of the same product, e.g., price reference material; and a drop-down input 34 to provide a predetermined packaged quantity also known as “material group package”, e.g., drum, bulk vessel, isocontainers, tank trucks, rail cars, bags, and so forth.

A third section 18 in the control section 12 is for selecting a particular time period and/or distribution channel 18. Under the heading of “period and distribution channel” 18, there are several inputs that the user can utilize to select sales transaction data associated with period and sales distribution information. Illustrative, but nonlimiting examples include: a drop-down input 36 to select a predetermined three month period, e.g., quarter; a drop-drop down input 38 to select a predetermined month; a drop-drop down input 40 to select a predetermined year; and a drop-down input 42 to select a predetermined customer group.

There is also special control section to allow the user to select specific sales transaction information that is generally indicated by numeral 48. Illustrative, but nonlimiting examples include: a drop-down input for a first predetermined customer group 50; a drop-down input for a second predetermined customer group 52; a drop-down input for a third predetermined customer group 54; and a drop-down input for a fourth predetermined customer group 56.

Also, under special controls 48 are a series of drop-down inputs for a predetermined segment of a market. Illustrative, but nonlimiting examples include: a drop-down input for a particular industry 58; a drop-down input for a particular market 60; a drop-down input for a particular segment of a market 62; and a drop-down input for a particular sub-segment of a market 64.

Other special controls 48 for other criteria can be available. Illustrative, but nonlimiting examples include: a drop-down input for a sub-group of a predetermined product 66; a drop-down input for a predetermined affiliation 68, which is a connection to other predetermined groupings of sales transaction data; and a drop-down input for a second predetermined packaged quantity or material group package 70, e.g., drum, bulk vessel, isocontainers, tank trucks, rail cars, bags, and so forth. There is also a drop-down input for a predetermined plant or facility 72.

There are a series of click-on inputs that can be utilized to exclude any of the inputs from either the control section 12 or the special control section 48, which are indicated by numeral 37. After all of the controls for filtering the sales transaction data through the control section 12 or special control section 48 have been selected, pushbutton 46 provides for execution of the selected controls to provide the selected sales transaction data to graphical representation tools described below. There is a pushbutton 44 that allows the user to reset the previously selected input provided through the control section 12 or special control section 48.

A first illustrative, but nonlimiting, graphical representation tool for analyzing data includes a fishtail analysis that is generally indicated by numeral 76. This may include a plot of plant gate pocket price “PGPP” indicated by numeral 78 versus cumulative quantity 80. Plant gate pocket price “PGPP” is defined as a gross sales price minus costs with the exception of raw material cost. The vertical lines, indicated by numeral 82, reflect various data collection points, e.g., manufacturing sites, terminals, warehouses, and so forth). The horizontal line, indicated by numeral 84, indicates a variable cost of raw materials based on market related prices. The plot indicated by numeral 86 is the plant gate pocket price “PGPP” of the selected customer and/or material combination. The distance between data points indicates the quantity of product that is sold. Also, this fishtail analysis provides combined margin plots for different packaging types or different periods to directly compare differences, changes and/or trends, e.g., drummed material versus bulk material.

A pushbutton 88 provides a freeze function for chart comparison. This allows comparison of identically selected controls throughout different periods of time, e.g., current month versus previous month. There is also a pushbutton 90 that erases the previously acquired frozen chart. Moreover, there is a click-on input 92 to provide full cost information in the fishtail analysis 76 and a click-on input 94 that will hide the full cost information in the fishtail analysis 76.

A second illustrative, but nonlimiting, tool for analyzing data includes a slope and scatter plot that is generally indicated by numeral 96. This is a plot of a variety of factors indicated by numeral 98 on the slope and scatter plot provided by drop-down input indicated by numeral 118. Illustrative, but nonlimiting examples of the various factors 118 include: a cash cost of accounts receivables (“CoC A/R”)/unit; allocated transaction/unit; average plant gate pocket price “PGPP”/unit; cash cost of inventory for a value of investment (“CoC Consignment”)/unit; commissions/unit; a cost to serve (“C2S”)/unit; duties and/or tariffs/unit; early payment discount (EPD)/unit; fixed costs/unit; a second imputed discount/unit; internal shipping costs/unit; net invoice/unit; last leg of freight charges/unit; net price/unit; discounts printed on an invoice/unit; packaging cost/unit; profit margin/unit; pocket margin/unit; variable costs/unit; small quantity upcharge/unit; target price/unit; top quartile price/unit; transactional corrections/unit; variable margin/unit; gross invoice/unit; and volume rebates/unit. These factors 98, provided by drop-down input 118, include a variety of waterfall elements described below.

The slope and scatter plot 96 includes the factors 98 plotted versus quantity indicated by numeral 100. There is a click-on input 102 for creation of a linear graph and a click-on input 104 for creation of a logarithmic graph. The quantity 100 can be in a variety of units 120, e.g., tons, U.S. Dollars, Euros, and so forth. There is a click-on input 101 to display customer names as labels and a click-on input 103 to the hide the customer names.

There is a data input for range 106, a data input for a lower limit 108 and a data limit for a higher limit 110. There is a pushbutton 112 to provide an input from the range 106, the lower limit 108 and the higher limit 110 to provide range selection to adjust probability ranges for quantity scaling on the X axis and or regression analysis. The limits 108 and 110 will exclude values falling outside of the limits and are indicated by numerals 111 and 113, respectively, on the slope and scatter chart 96. The range 106 can allow the user to determine the percentage of data points falling within the limits 108 and 110. A pushbutton input 114 allows data from various sources, e.g., marketing account representatives, to appear in different colors. There is a pushbutton input 122 that allows the user to suppress the appearance of zeros on the slope and scatter plot 96. This is a helpful function in a variety of situations, e.g., customer pick-up, volume rebate levels.

A customer function 116 assists the user in identifying the party that is receiving the sale of the goods. This is utilized in providing an appropriate view for analysis. Illustrative, but nonlimiting examples of the customer function 116 include, but are not limited to: a negotiating party; a sold-to party; a shipping party; and a global parent. An output variable for the slope and scatter plot 96 allows analysis of all pricing elements. This is preferably performed along the Y axis.

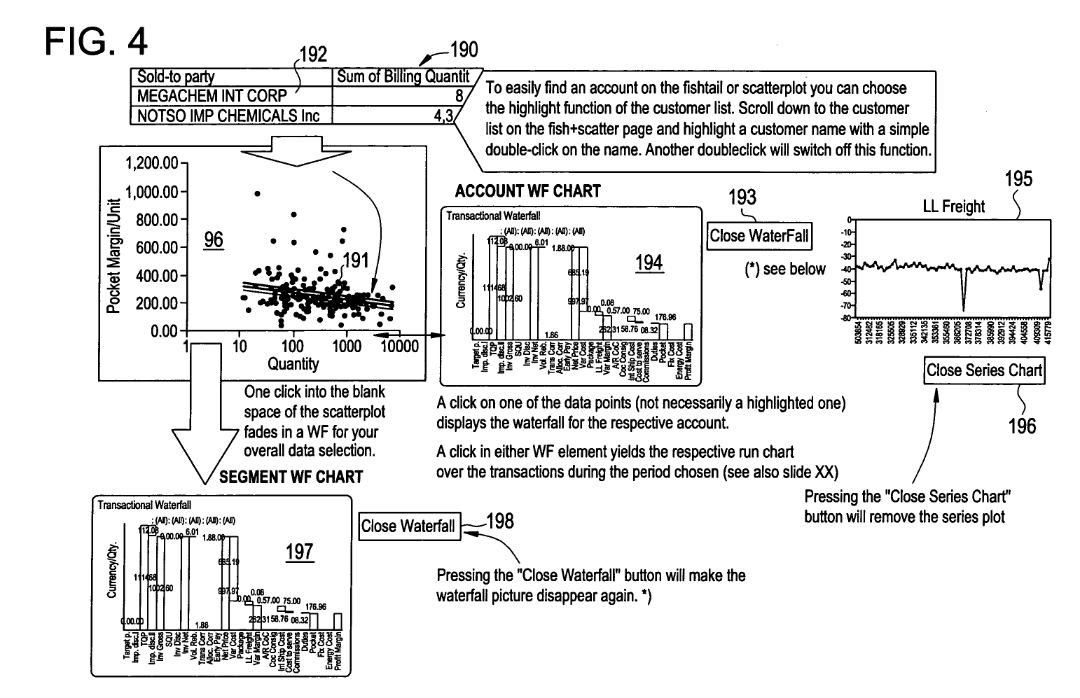

As shown in FIG. 4 and generally indicated by numeral 190, there is an ability for the user to click on a customer from a listing 192 to located a particular account on the slope and scatter chart 96 as well as the fishtail analysis 76, shown in FIG. 1. Clicking a data point on the slope and scatter chart 96 can create an account waterfall chart 194. A click on a waterfall element 191 will yield a respective run chart over the transactions during the period chosen.

There is a pushbutton icon 193 to close the waterfall chart 194. Clicking on a waterfall element on the account waterfall chart 194 will create a series chart 195. There is a pushbutton icon 196 to close the series chart 195. The user can click on the scatter plot 96 to create a transactional waterfall chart 197. There is a pushbutton icon 198 to close the transactional waterfall chart 197.

Referring again to FIG. 1, a price and margin solver is an additional tool that is indicated by numeral 124. This includes an equation 126 representing the slope and scatter plot 96 indicated by numeral 109. The upper limit 110 is shown on the slope and scatter plot 96 by numeral 113 and the lower limit 108 is shown by numeral 111.

The desired target quantity can be changed through data input 128. The result target is generated and indicated by data output 130, which depends on the type of factor indicated by numeral 118. The conformance with the target is indicated by data output 132 as range of values both positive and negative. The distance from the trend line is indicated by numeral 134, and the distance from the lower confidence limit is indicated by numeral 136. When the values are outside of these limits, the output can turn another predetermined color, e.g., red, to provide this as an indication.

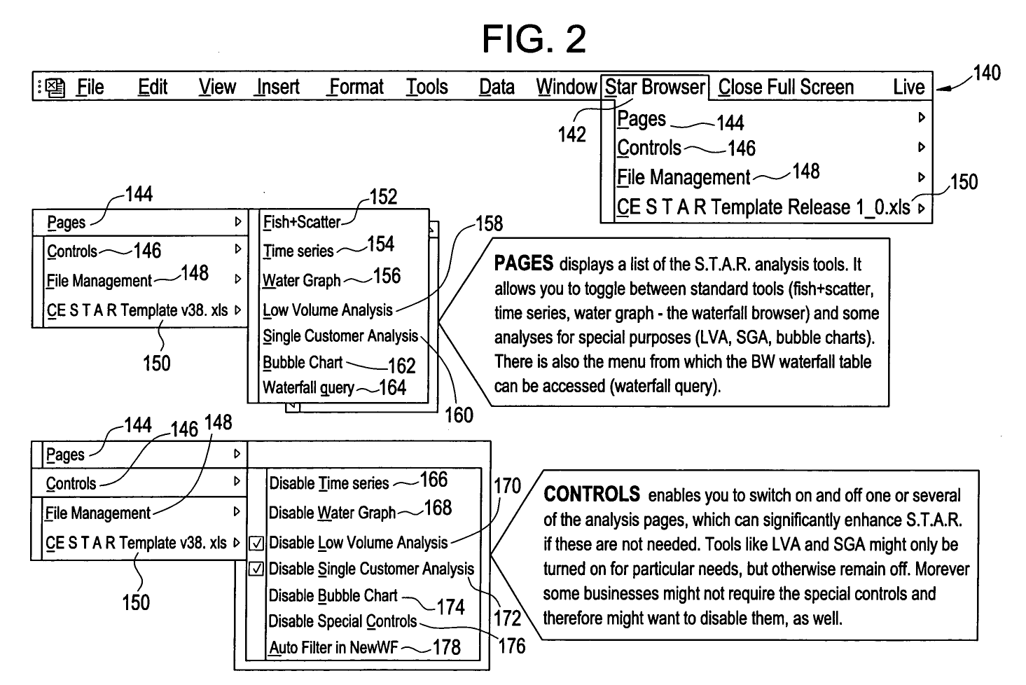

There is a header menu indicated by numeral 140. Located with the header menu 140 is a star browser 142 that allows the user to navigate between the different tools for sales transaction analysis. As shown in FIG. 2, the star browser 142 provides a “pages” function 144 that displays a list of various tools for analysis, which includes: a fish and scatter chart 152; a time series chart 154; a water graph 156; low volume analysis 158; a single customer analysis 160; a bubble chart 162; and a waterfall query 164.

There is a control function 146 that allows the user to switch off one or more of the analysis tools. This includes: disabling a time series chart 166; disabling a water graph 168; disabling low volume analysis 170; disabling single customer analysis 172; disabling a bubble chart 174; disabling special controls 176; and provide an automatic filter in a new waterfall 178.

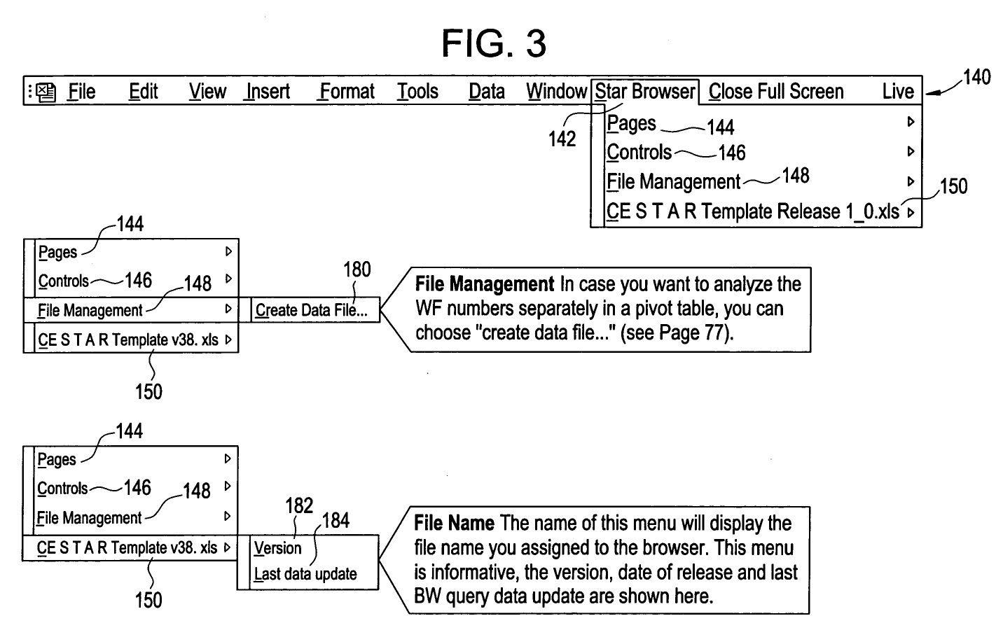

A file management function is indicated by numeral 148 in FIG. 3. This file management function 148, provides a data file creation feature 180 so that waterfall numbers can be separately analyzed in a pivot table. There is a CE Star Template function 150 that provides information about the version 182 of the star browser 142. This may include a version identification, date of release, file name, and so forth. There is also a function to determine the last date when sales transaction data was provided to the system 184.

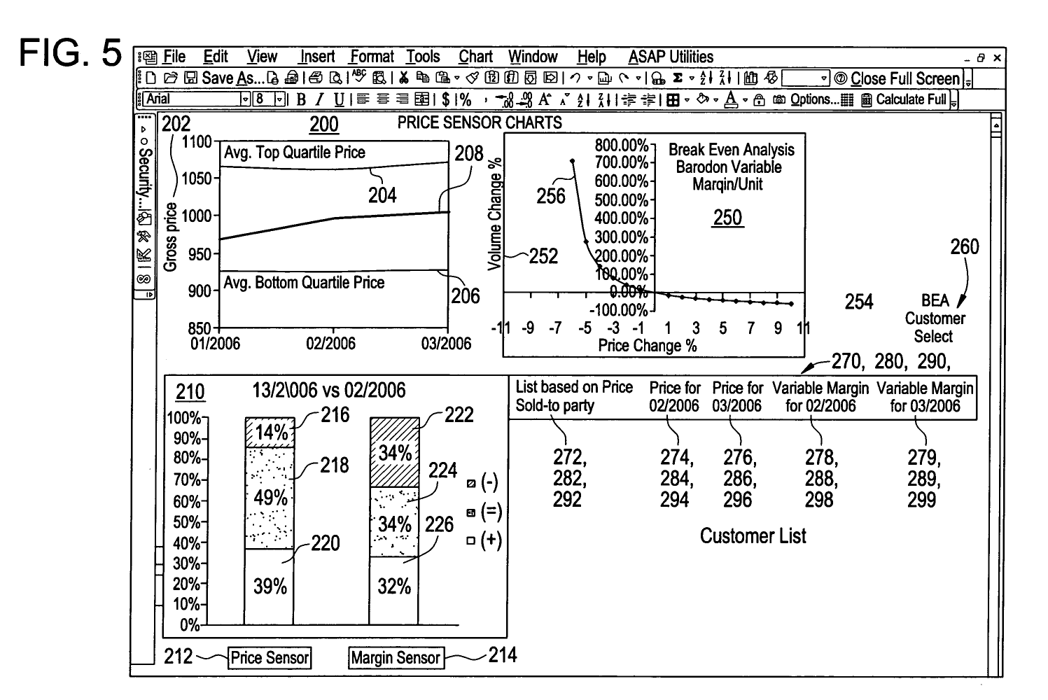

A time series chart is indicated by numeral 200 in FIG. 5. There is an average top quartile price (“TCP”) indicated by numeral 204, an average bottom quartile price (“BCP”) indicated by numeral 206 and an average price plot indicated by numeral 208. The time series chart 200 provides a general overview of a gross price 202 and provides fine tuning of the navigation of a price sensor and margin sensor that is generally indicated by numeral 210. When the user clicks on two points on the average price plot 208, a corresponding price sensor 212 and corresponding margin sensor 214 will be generated.

The price sensor 212 includes a first portion 216, where the price has decreased by a predetermined percentage, e.g., one percent (1%) or more, a second portion 218, where the price has changed by less than a predetermined percentage, e.g., one percent (1%), and a third portion 220, where the price has increased by a predetermined percentage, e.g., one percent (1%) or more. The price sensor 212 provides comparisons between last and actual month based on revenue.

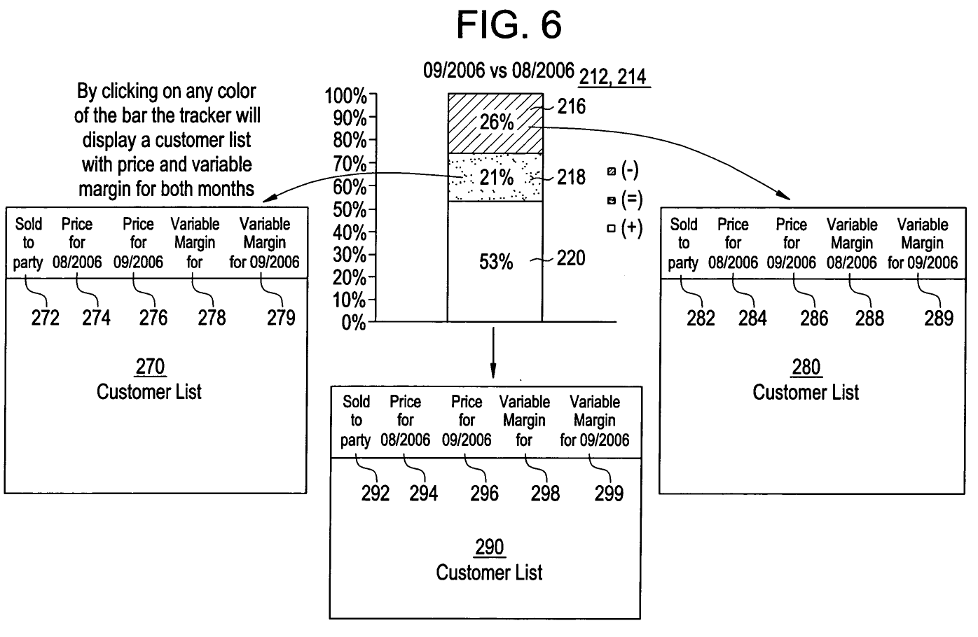

As shown in FIGS. 5 and 6, clicking on the first portion 216 generates a customer list 270 having a customer 272, e.g., sold-to-party, a price for a first predetermined period 274, e.g., month, a price for a second predetermined period 276, e.g., month, a variable margin for a first predetermined period 278, e.g., month, and a variable margin for a second predetermined period 279, e.g., month. Also, clicking on the second portion 218 generates a customer list 280 having a customer 282, e.g., sold-to-party, a price for a first predetermined period 284, e.g., month, a price for a second predetermined period 286, e.g., month, a variable margin for a first predetermined period 288, e.g., month, and a variable margin for a second predetermined period 289, e.g., month. Moreover, clicking on the third portion 220 generates a customer list 290 having a customer 292, e.g., sold-to-party, a price for a first predetermined period 294, e.g., month, a price for a second predetermined period 296, e.g., month, a variable margin for a first predetermined period 298, e.g., month, and a variable margin for a second predetermined period 299, e.g., month.

The margin sensor 214 includes a first portion 222, where the margin has decreased by a predetermined percentage, e.g., one percent (1%) or more, a second portion 224, where the margin has changed by less than predetermined percentage, e.g., one percent (1%) and a third portion 226, where the margin has increased by a predetermined percentage, e.g., one percent (1%) or more. Clicking on the first portion 222 generates a customer list 270 having a customer 272, e.g., sold-to-party, a price for a first predetermined period 274, e.g., month, a price for a second predetermined period 276, e.g., month, a variable margin for a first predetermined period 278, e.g., month, and a variable margin for a second predetermined period 279, e.g., month. Also, clicking on the second portion 224 generates a customer list 280 having a customer 282, e.g., sold-to-party, a price for a first predetermined period 284, e.g., month, a price for a second predetermined period 286, e.g., month, a variable margin for a first predetermined period 288, e.g., month, and a variable margin for a second predetermined period 289, e.g., month. Moreover, clicking on the third portion 226 generates a customer list 290 having a customer 292, e.g., sold-to-party, a price for a first predetermined period 294, e.g., month, a price for a second predetermined period 296, e.g., month, a variable margin for a first predetermined period 298, e.g., month, and a variable margin for a second predetermined period 299, e.g., month.

The user can click on any two points in the average price plot indicated by numeral 208 and a corresponding price sensor 212 display will be generated to provide a price comparison and a corresponding margin sensor 214 display will be generated to provide a margin comparison. The price sensor 212 and the margin sensor 214 will detail lists of increasing or decreasing price/margin customers. The source code algorithms utilized to drill down points on a graph to other graphical images or information throughout this patent application is contained in Appendix A and incorporated herein by reference.

A break-even analysis tool is generally indicated by numeral 250. This tool involves a graphical representation of percentage of volume change 252 versus percentage of price change percent 254, which is indicated by plot 256. This break-even analysis tool 250 provides insight as to how much volume is required to break even if the price is cut. There is a data input 260 that allows the user to select a particular customer, all customers, or a predetermined subset thereof. The responsiveness of demand to price changes is illustrated in the break-even analysis tool 250.

Depending on the user's selections under controls 12 and special controls 48 in FIG. 1, the break-even analysis tool 250 measures the theoretical responsiveness or change in quantity demanded of a product 252, which is illustrated along the Y axis, to a change in price in this same quantity demanded of this predetermined product 254, which is illustrated along the X axis. As an assumption for this break-even analysis, all cost terms are assumed to remain static. The X axis 254 provides a hypothetical change in price in percent with a positive value being a price increase and a negative value being a price decrease. The Y axis 252 provides a hypothetical loss or gain in sales volume in percent. The break-even analysis tool 250 explores the theoretical impact on sales volume after a change in price. Each data point on the plot 256 represents a hypothetical break-even value for absolute pocket margin. The calculation is based on the selection, provided by the user, through controls 12 and special controls 48 in FIG. 1 so that if a particular time interval, e.g., month, is selected, all projections are calculated based on the average gross sales price and absolute pocket marking for this same time interval, e.g., month. This would allow the user to determine if there is a hypothetical increase in price, what sales could be lost to generate the same pocket margin during the same time interval, e.g., month.

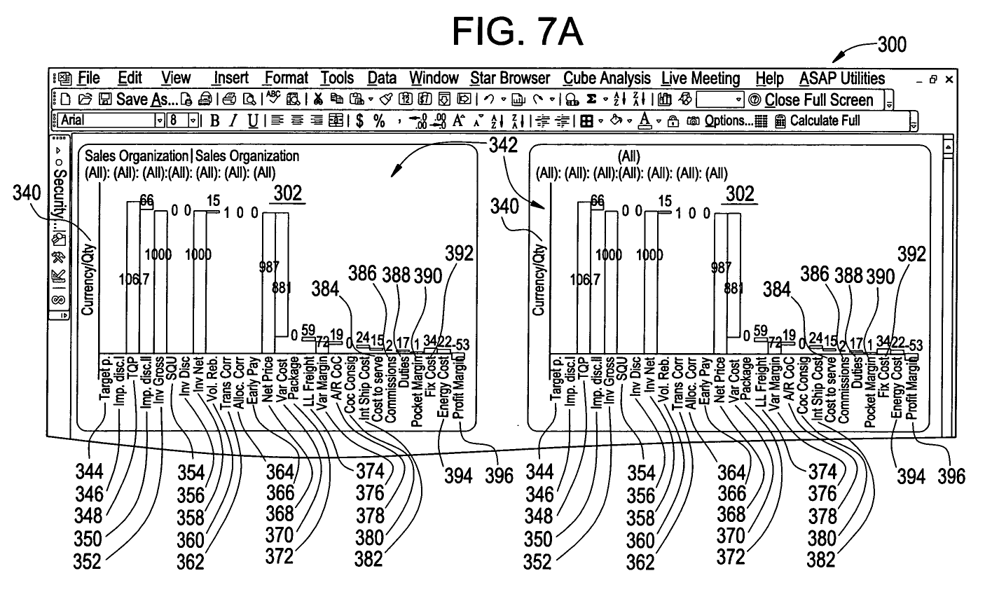

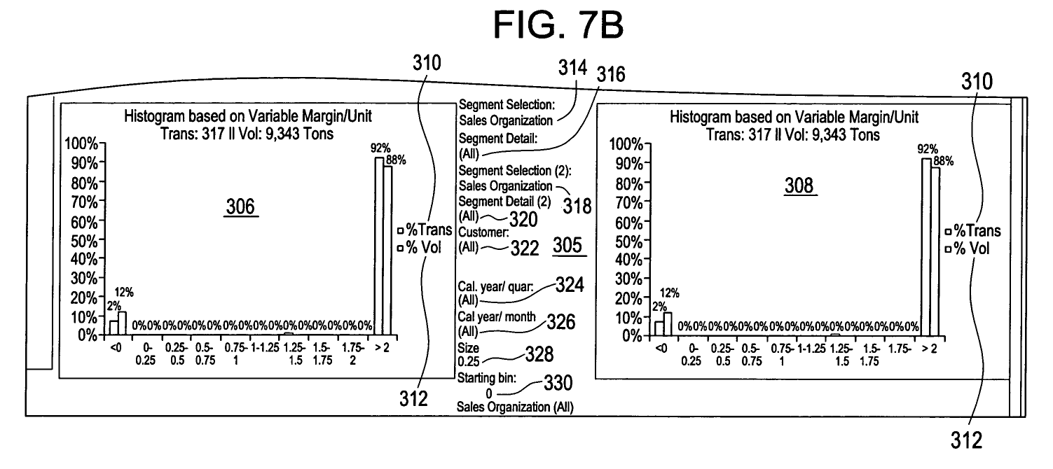

Another sales analysis tool is a waterfall analysis that is activated through control 156 shown on FIG. 2. The waterfall graphical analysis is generally indicated by numeral 300 on FIG. 7. In this illustrative, but nonlimiting, embodiment there is a first transactional waterfall 302. The first transactional waterfall 302 is associated with a first histogram of variable margin or pocket margin per unit 306. There is a filtering and histogram control indicated by numeral 305. Illustrative, but nonlimiting, input that can be provided to the filtering and histogram control 305 includes, but is not limited to: a first sales organization 314; a first segment detail 316; a second segment selection 318; a second segment detail 320; a customer 322; a first calculated predetermined period, e.g., quarter 324; a second calculated predetermined period, e.g., month 326; size of a material handling group 328; and a material handling container, e.g., starting bin 330. The size 328 and starting bin 330 can be customized by the user. The utilization of the filtering and histogram control 305 generates a second transactional waterfall 304 and a second histogram 308. There are a percentage of transactions 310 and a percentage of volume 312 found on both a first histogram 306 and a second histogram 308.

The first transactional waterfall 302 and the second transactional waterfall 304 provide a graphical representation of currency/quantity in relationship to all of the contributing factors that are generally indicated by numeral 342. This is helpful to prevent cost leakage. These factors 342 can include a target price 344, e.g., list price, base price; an invoice gross 352, e.g., a sales order price, which is the price at which a customer places an order directly related to the price of every real time sales transaction/order item in the system. There is a first imputed discount 346, which is the difference between a target price 344 and the invoice gross 352, e.g., a sales order price. Also, these factors 342 include a top quartile price 348, e.g., which is the top 25% of all prices determined by predetermined market segment during a predetermined time period, e.g., quarter, for a particular product identification, e.g., stock keeping unit (“SKU”). Also, a second imputed discount 350, which is the difference between the top quartile price 348 and the invoice gross 352, e.g., a sales order price. Moreover, these factors 342 include: a small quantity upcharge (“SQU”) 354; discounts printed on an invoice (on-invoice discounts) 356; an invoice net 358, e.g., invoice price appearing on invoice document; a volume rebate 360, which are accruals for rebates on a transaction level based on preexisting agreements; transactional corrections 362, which are credit and debit memorandums entered into the system based on a reference document; allocated corrections 364, which are credit and debit memorandums that are not based on a reference document and manually allocated to a predetermined period; and early payment discount(s) (“EPD”) 366 that is typically based so that the customer could always apply for an early payment discount, or a predetermined percentage of customers would apply for an early payment discount.

The net price 368 is the invoice gross 352, e.g., a sales order price minus the small quantity upcharge (“SQU”) 354, discounts printed on an invoice (on-invoice discounts) 356, invoice net 358, e.g., invoice price appearing on invoice document, volume rebate 360, transactional corrections 362, allocated corrections 364, and early payment discount(s) (“EPD”) 366.

There are a number of other contributing factors 342 that are utilized to arrive at margin values. These include a variable cost of raw materials 370, which is based at the manufacturing plant or other location of origin for the raw materials; packaging cost 372, which is an additional cost of packaged goods for a predetermined packaged unit, e.g., stock keeping unit (“SKU”); a last leg of freight charges 374, which is the freight charges from the last facility e.g., terminal, warehouse, to a customer. The variable margin is indicated by numeral 376 and includes the net price 368 minus the variable cost of raw materials 370, packaging cost 372, and a last leg of freight charges 374.

Remaining contributing factors 342 include a cash cost of accounts receivables 378 (“CoC A/R), which is calculated from invoiced amount and a WACC of ten percent (10%) utilizing actual payment days. “WACC” is defined as (Cost of equity) (Equity/Capital)+(Cost of debt (1−tax rate)) (Debt/Capital). There is also a cash cost of inventory for a value of investment 380 (“CoC Consignment”). An internal shipment cost 382 provides freight costs between terminals and warehouses accumulated for multiple legs of travel. This includes resupplies. A cost to serve (“C2S”) is indicated by numeral 384, which includes an allocated cost of selling, overhead, other distribution and research and development (“SG&A”). Commissions, which include service fees and compensation paid to sales agents, are indicated by numeral 386. Duties, which includes custom charges for internal or external deliveries is indicated by numeral 388. The pocket margin 390 is calculated by taking the variable margin indicated by numeral 376 minus a cash cost of accounts receivables 378, a cash cost of inventory 380, an internal shipment cost 382, a cost to serve (“C2S”) 384, commissions 386, and duties 388.

There is a calculation of a fixed costs 392, which is a cost of labor and maintenance for a predetermined period of time; energy costs 394; and finally a profit margin 396, which is the pocket margin 390 minus the fixed costs 392 and the energy costs 394.

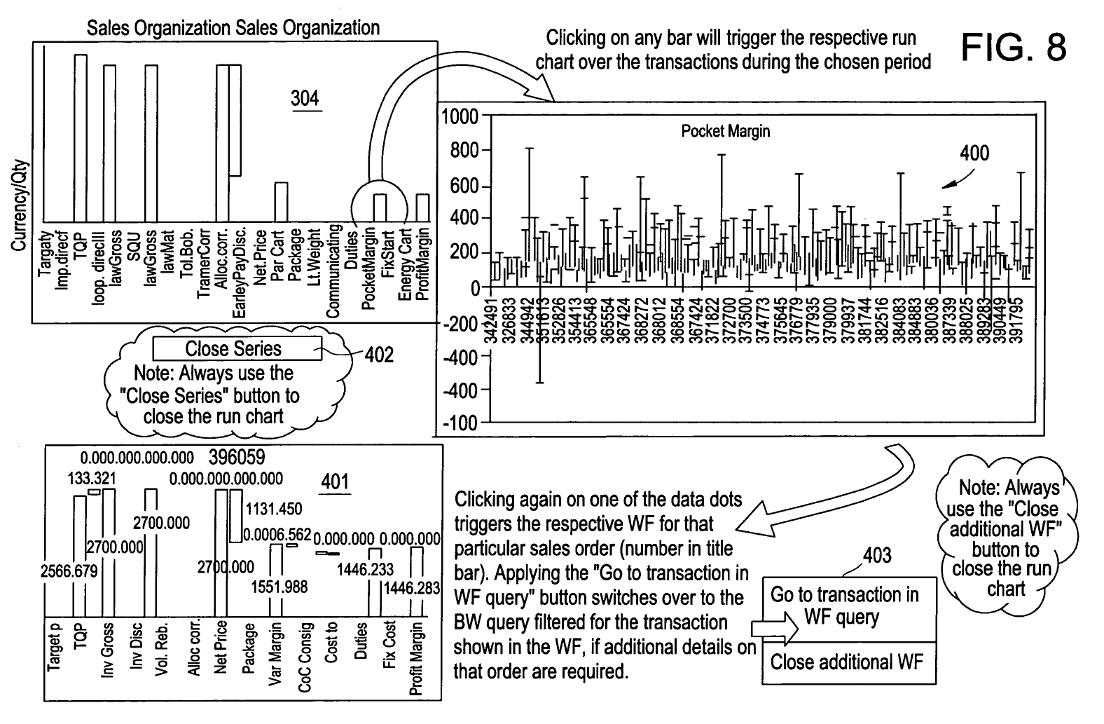

The user clicking on any of the contributing factors 342 will trigger a run chart, as shown in FIG. 8, which is generally indicated by numeral 400. There is a pushbutton 402 that closes the run chart 400. When the user clicks on one of the contributing factors on the run chart 400 will trigger a waterfall graph 401 for that respective sales order and/or transaction. If additional details are required, an additional pushbutton icon 403 is available.

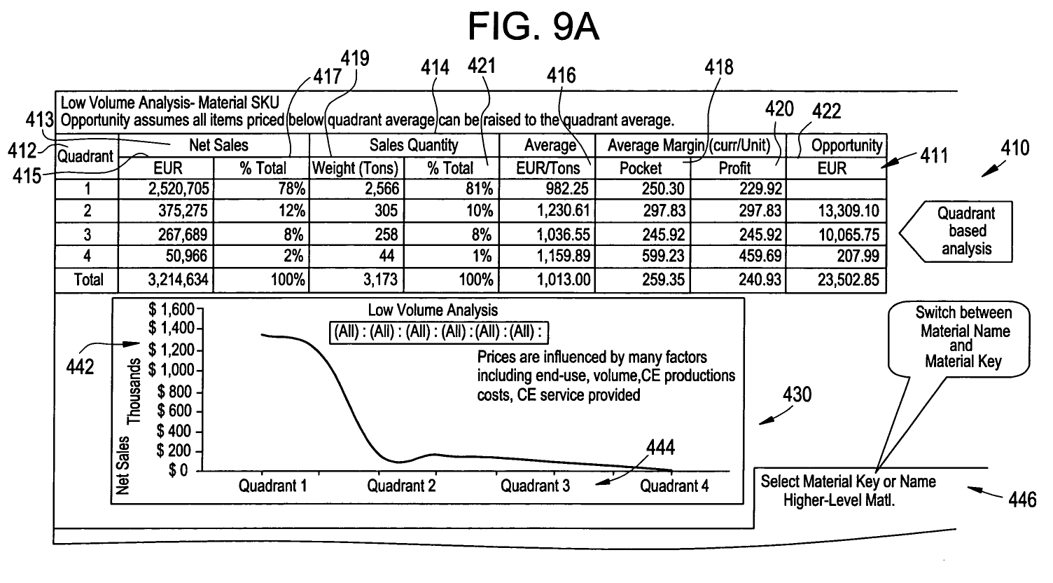

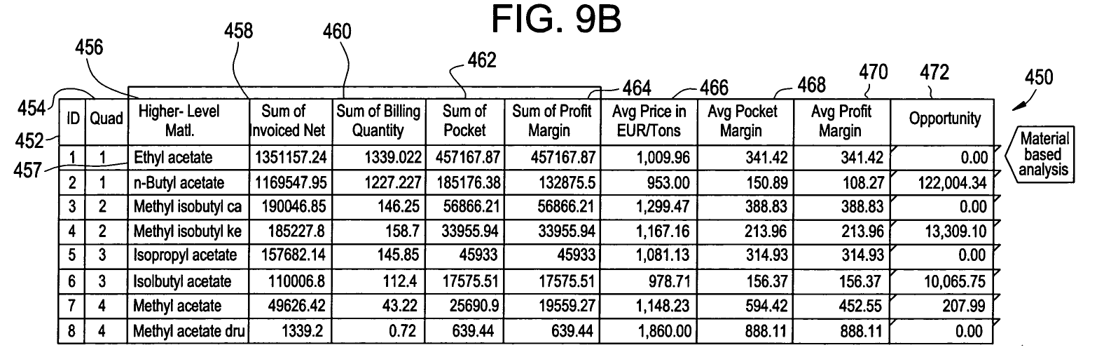

Another sales analysis tool is low volume analysis that is activated through control 158 shown on FIG. 2. The low volume analysis is generally indicated by numeral 410 on FIG. 9. In this illustrative, but nonlimiting, embodiment there is a table 411 for particular product identifications, e.g., stock keeping units (“SKUs”) in decreasing order according to net sales 413 and grouped according to quadrants 412. Net sales 413 provides both a monetary amount 415 and a percentage of total 417, and sales quantity 414 provides a weight 419 and a percentage of total 421. An average sales/quantity 416 is also provided. For each quadrant the specific average pocket margin 418 and profit margin 420 is determined along with a potential benefit 422, which is the difference of pocket margin 418 and profit margin 420 times the quantity sold 414. Preferably, but not necessarily, this is calculated for those particular product identifications, e.g., stock keeping units (“SKUs”) that have margins falling below its quadrant's average value. This low volume analysis is very helpful for businesses with a complex product portfolio with numerous grades, material codes, and so forth to single out underperforming sales with a meaningful, business related dataset utilized during an appropriate, predetermined time period.

The low volume analysis tool 410 can then generate a graphical representation 430 of net sales 442 versus a time period 444, e.g., quadrant; there is a switch 446 that allows the user to go between a material name and a material key. A table of material based analysis is shown on table 450. This includes a column for: material identification 452, e.g., I.D.; a time period 454, e.g., quadrant 454; a material subgroup 456, e.g., higher level material; a sum of net invoice 458; a sum of billing quantity 460; a sum of pocket 462; a sum of profit margin 464; an average price per weight 466, e.g., EUR/ton; an average pocket margin 468; an average profit margin 470 and an opportunity 472. When the user double clicks on a particular material name 457 within the column for a material subgroup 456, e.g., higher level material, a listing of customers who purchased this product during a predetermined time period can be analyzed.

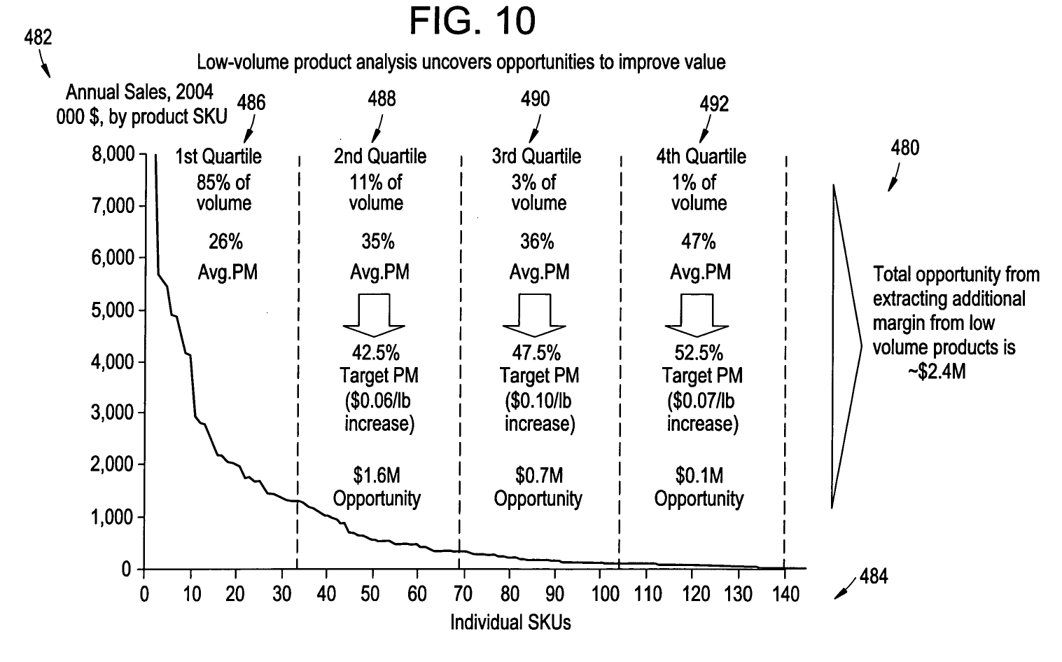

Moreover, the low volume analysis tool 410 can also generate a graphical analysis 480 of annual sales 482 versus particular product identifications 484, e.g., stock keeping units (“SKUs”), as shown in FIG. 10. This is broken down by predetermined time units, e.g., quarters, with a first quartile 486, a second quartile 488, a third quartile 490, and a fourth quartile 492.

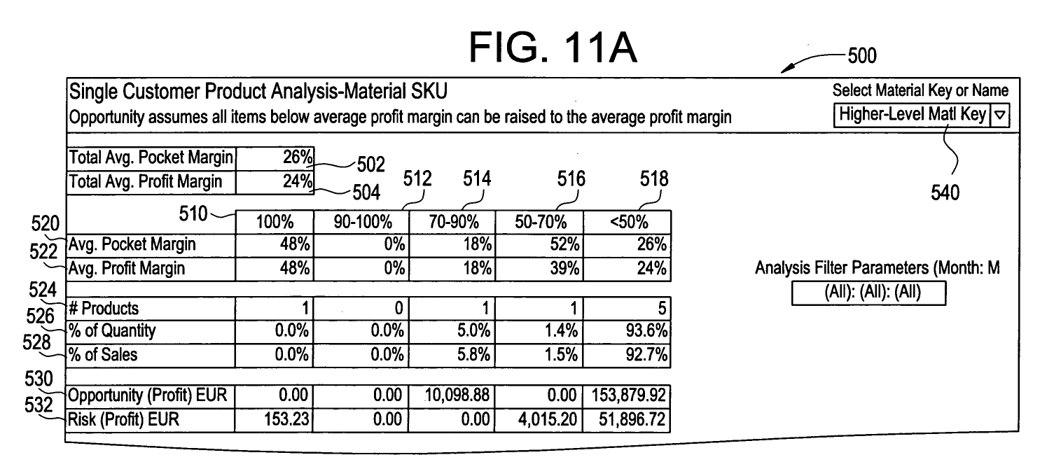

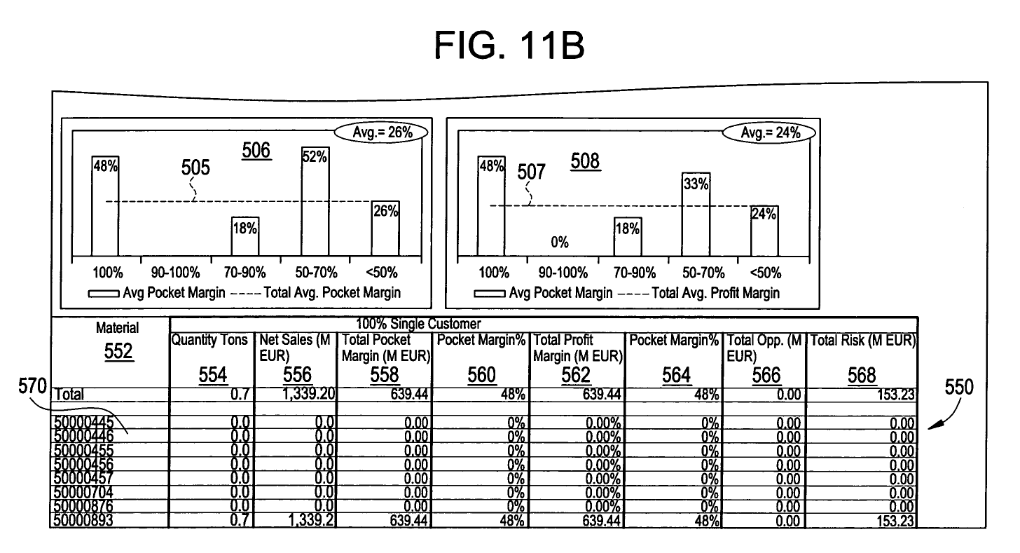

Still another sales analysis tool is single customer analysis that is activated through control 160 shown on FIG. 2 and provides a sanity check on exclusively manufactured materials utilized by primarily one customer. The single customer analysis is generally indicated by numeral 500 on FIG. 11. In this illustrative, but nonlimiting, embodiment there is a graphical output for total average pocket margin 502 and total average profit margin 504. As a general principle, it is desired that margins and values for these single customers should exceed the average due to the additional labor, longer equipment downtime and additional plant maintenance required. The ability to ascertain the success or failure of capturing sufficient value is shown in a bar graph of average pocket margin 506 and a bar graph of average profit margin 508. The dashed line 505 is average pocket margin and dashed line 507 is average profit margin for all products being analyzed. Single customer analysis 500 should be applied for businesses with a highly complex material/customer mix with numerous grades or material codes, to single out underperforming sales. As with any sales transaction analysis tool, a meaningful, business-related dataset within an appropriate predetermined time period improves the accuracy of the results.

There is a table of values within predetermined columns of dependency on a particular customer. These predetermined columns of dependency include a predetermined percentage 510, e.g., one hundred percent (100%), of an entire production of a product goes to a single account, a first range of predetermined percentages 512, e.g., ninety (90%) to one hundred percent (100%), of the production of a product goes to a single account; a second range of predetermined percentages 514, e.g., seventy (70%) to ninety percent (90%), of the production of a product goes to a single account; a third range of predetermined percentages 516, e.g., fifty (50%) to seventy percent (70%), of the production of a product goes to a single account; and a fourth range of less than a predetermined percentage 518, e.g., fifty (50%), of the production of a product goes to a single account. This is for: average pocket margin 520; average profit margin 522; number of products 524; percentage of quantity 526; percentage of sales 528; opportunity (profit) 530 and risk (profit) 532. Opportunity is defined as additional potential value if margins can be raised to at least overall average (which can be achieved through either cutting costs or increasing prices to compensate for additional costs and services). Risk is defined as an estimate of potential loss, e.g., if entire sales disappeared or production is ceased.

The average pocket and profit margins 502 and 504 can belong to individual single customer dependence ranges based on the number of particular product identifications, e.g., stock keeping units (“SKUs”) in an individual single customer dependence range. The contribution to total sales is found in percentage of billing quantity and net sales. The general expectation is that high individual single customer dependence (“SCD”) ranges generate margins significantly above average, and SCD ranges to the right edge show margins around average or slightly below as shown in the bar graph of average pocket margin 506 and the bar graph of average profit margin 508.

There is an input 540 to select either a material key or a higher level material. A detail table is generally indicated by numeral 550 and can utilize the “Furey” scale. There is a listing of: materials 552; quantity in weight 554, e.g., tons; net sales 556; total return based on pocket margin 558; relative percentage of pocket margin 560; total return based on profit margin 562; relative percentage of total profit margin 564; total opportunity 566; and total risk 568. The materials 552 and quantity in weight 554 are both in terms of a particular product identification, e.g., stock keeping units (“SKUs”). A double click on a particular material name or key 570 will display a listing of customers who purchased this particular product during the predetermined time period.

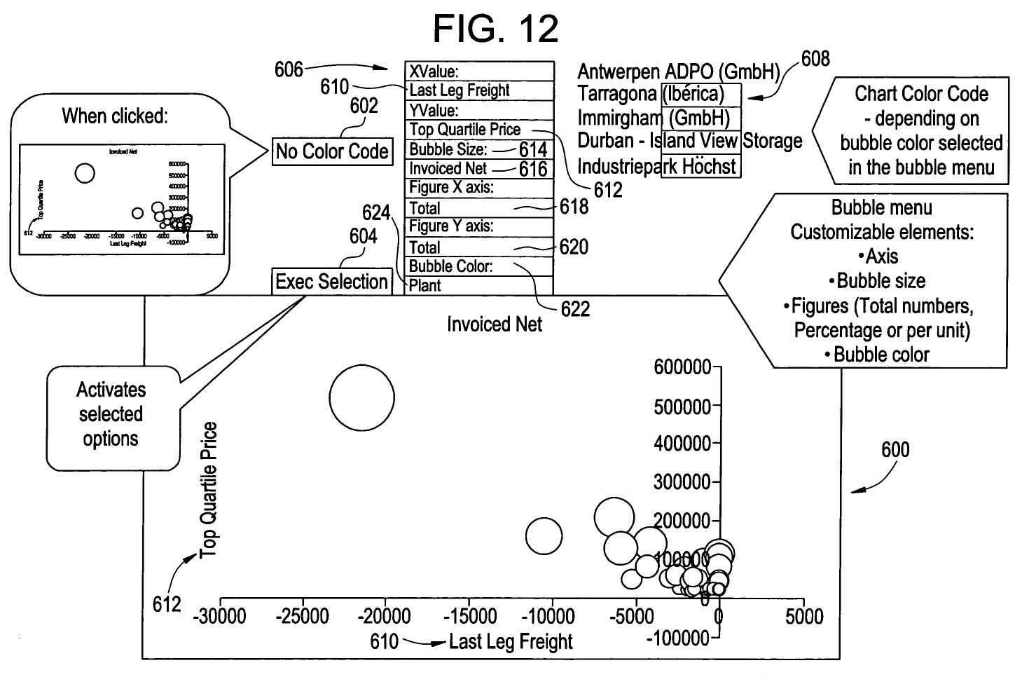

Finally, another sales analysis tool is a transactional waterfall bubble chart that is activated through control 162 shown on FIG. 2. The transactional waterfall bubble chart is generally indicated by numeral 600 on FIG. 12. There is a pushbutton icon 602 to remove the color coding and a pushbutton icon 604 that allows the transactional waterfall bubble chart 600 to be created based on a listing of menu items 606. There is a color code 608 that indicates various items, e.g. countries, and associated color for that particular menu item. The listing of menu items 606 includes a value for the X axis 610. Illustrative, but nonlimiting examples of values for the X axis 610 include in drop-down entry format: pocket margin; last leg freight; packaging costs; volume rebates; cash cost of accounts receivables (“CoC A/R”); total freight; profit margin; and variable margin. The listing of menu items 606 includes a value for the Y axis 612. Illustrative, but nonlimiting examples of values for the X axis 612 include in drop-down entry format: invoice gross; net price; target price; and top quartile price. The listing of menu items 606 includes: a data entry for a bubble size 614; a drop-down value for invoiced net or billing quantity 616; a drop-down input 618 for per unit, total or percentage as type of figures on X axis; a drop-down input 620 for per unit or total as type of figures on Y axis; a data input for bubble color 622; and a drop-down input for customer grouping 624, e.g., market sub-segment, ship-to country, primary sales representative, country (geographic region), material packaging grouping, plant, sales organization, and a sort field.

The various examples shown above illustrate a novel sales transaction, analysis and reporting tool and associated method of use. A user of the present invention may choose any of the above embodiments, or an equivalent thereof, depending upon the desired application. In this regard, it is recognized that various forms of the subject invention could be utilized without departing from the spirit and scope of the present invention.

Other aspects, objects and advantages of the present invention can be obtained from a study of the drawings, the disclosure and the appended claims. Thus, there has been shown and described several embodiments of a novel and non-obvious invention. As is evident from the foregoing description, certain aspects of the present invention are not limited by the particular details of the examples illustrated herein, and it is therefore contemplated that other modifications and applications, or equivalents thereof, will occur to those skilled in the art. The terms “have,” “having,” “includes” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention, which is limited only by the claims that follow.

What is claimed is:

1. A sales transaction tool comprising:
at least one processor configured to receive sales transaction information, said processor being programmed to provide the following functionality;
a series of control functions that can be selectively activated by user input to the at least one processor for creating at least one subset of the sales transaction information;
a plurality of graphical representations that are generated based on the selected subset of sales transaction information; and
said processor having at least one electrically connected electronic display for displaying at least one of said graphical representations.

2. The sales transaction tool according to claim 1, wherein the series of control functions includes at least one regional-type control.

3. The sales transaction tool according to claim 2, wherein the at least one regional-type control is selected from the group consisting of at least one predetermined sales organization, at least one predetermined geographic region, at least one predetermined country where products are shipped, or at least one sales representative.

4. The sales transaction tool according to claim 1, wherein the series of control functions includes at least one product-type control.

5. The sales transaction tool according to claim 4, wherein the at least one product-type control is selected from the group consisting of predetermined product information, a subgrouping of a predetermined product, a component for a predetermined product component, a different version of a predetermined product, a different category of a predetermined product, or a predetermined material handling group for a predetermined product.

6. The sales transaction tool according to claim 1, wherein the series of control functions includes at least one time period-type control.

7. The sales transaction tool according to claim 6, wherein the at least one time period-type control is selected from the group consisting of a predetermined quarter, a predetermined month or a predetermined year.

8. The sales transaction tool according to claim 1, wherein the series of control functions includes at least one predetermined grouping of customers.

9. The sales transaction tool according to claim 1, wherein the series of control functions includes at least one of a predetermined market and a predetermined submarket.

10. The sales transaction tool according to claim 1, wherein the series of control functions includes at least one predetermined affiliated party.

11. The sales transaction tool according to claim 1, wherein the plurality of graphical representations includes at least one graphical representation of gross sales price information minus predetermined cost elements versus quantity.

12. The sales transaction tool according to claim 11, wherein the cost elements can selectively exclude predetermined cost elements selected from the group including at least one of raw materials, fixed costs and energy costs.

13. The sales transaction tool according to claim 11, wherein the at least one graphical representation of gross sales price information minus predetermined cost elements versus quantity is graphically presented with fishtail analysis.

14. The sales transaction tool according to claim 11, wherein the at least one a graphical representation of gross sales price information minus predetermined cost elements versus cumulative quantity can be compared against another graphical representation of gross sales price information minus predetermined cost elements versus quantity.

15. The sales transaction tool according to claim 1, wherein the plurality of graphical representations includes at least one slope and scatter diagram of sales transaction information selected from the group consisting of a target price, an invoice gross, a first imputed discount, a sales order price, a top quartile price, a second imputed discount, a small quantity upcharge, discounts printed on an invoice, invoice net, volume rebate, transactional corrections, allocated corrections, early payment discount(s), net price, variable cost of raw materials, packaging costs, last leg of freight charges, variable margin, net price, cash cost of accounts receivables, cash cost of inventory, internal shipment cost, cost to serve, commissions, duties, pocket margin, fixed costs, energy costs or profit margin versus quantity.

16. The sales transaction tool according to claim 15, wherein the slope and scatter diagram can be utilized to generate a waterfall chart.

17. The sales transaction tool according to claim 16, wherein the generated waterfall chart can be based on a predetermined customer's data.

18. The sales transaction tool according to claim 16, wherein the generated waterfall chart diagram can be utilized to generate a series chart.

19. The sales transaction tool according to claim 15, wherein the slope and scatter diagram includes a logarithmic graph.

20. The sales transaction tool according to claim 1, further comprising a price and margin solver for estimating at least one of a price element, a margin element and a cost element.

21. The sales transaction tool according to claim 1, wherein the price and margin solver utilizes at least one of a target and a confidence level.

22. The sales transaction tool according to claim 1, wherein the plurality of graphical representations includes at least one of a time series chart, a price sensor, a margin sensor and a break-even analysis graph.

23. The sales transaction tool according to claim 22, wherein the price sensor includes a first portion that is a price decrease of a predetermined percentage or more and a second portion that is a price change of the predetermined percentage or less and a third portion that is a price increase of the predetermined percentage or more.

24. The sales transaction tool according to claim 22, wherein the margin sensor includes a first portion that is a margin decrease of a predetermined percentage or more and a second portion that is a margin change of the predetermined percentage or less and a third portion that is a margin increase of the predetermined percentage or more.

25. The sales transaction tool according to claim 22, wherein the time series chart includes a representation of price over time.

26. The sales transaction tool according to claim 22, wherein the break-even analysis graph evaluates volume change in relationship to price change.

27. The sales transaction tool according to claim 1, wherein the plurality of graphical representations includes at least one waterfall analysis of sales transaction information selected from the group consisting of a target price, an invoice gross, a first imputed discount, a sales order price, a top quartile price, a second imputed discount, a small quantity upcharge, discounts printed on an invoice, invoice net, volume rebate, transactional corrections, allocated corrections, early payment discount(s), net price, variable cost of raw materials, packaging cost, last leg of freight charges, variable margin, net price, cash cost of accounts receivables, cash cost of inventory, internal shipment cost, cost to serve, commissions, duties, pocket margin, fixed costs, energy costs or profit margin versus quantity.

28. The sales transaction tool according to claim 27, wherein the at least one waterfall analysis of sales transaction information generates at least one of a histogram and a time series chart.

29. The sales transaction tool according to claim 27, further comprising a filter that obtains a subgroup of the sales transaction information to generate at least one additional waterfall analysis.

30. The sales transaction tool according to claim 29, wherein the at least one additional waterfall analysis of the subgroup of sales transaction information generates at least one of a histogram and a series chart.

31. The sales transaction tool according to claim 1, further comprising a low volume analysis tool for estimating opportunity of moving low margin products to average margins of comparable products, which generates a graphical representation of sales and at least one of profit margin and pocket margin over predetermined time periods.

32. The sales transaction tool according to claim 1, further comprising a single customer analysis tool for determining value with a single customer, which generates a graphical representation of least one of profit margin and pocket margin and at least one of percentage of quantity and percentage of sales over predetermined percentages of customer dependence.

33. The sales transaction tool according to claim 32, wherein the graphical representation includes at least one of opportunity and risk.

34. The sales transaction tool according to claim 1, further comprising a transactional waterfall bubble chart that shows at least one of invoice gross, net price, target price, and top quartile price in relationship to at least one of a target price, an invoice gross, a first imputed discount, a second imputed discount, a small quantity upcharge, discounts printed on an invoice, volume rebate, transactional corrections, allocated corrections, early payment discount(s), variable cost of raw materials, packaging cost, last leg of freight charges, variable margin, cash cost of accounts receivables, cash cost of inventory, internal shipment cost, cost to serve, commissions, duties, pocket margin, fixed costs, energy costs and profit margin.

35. A sales transaction tool comprising:
at least one processor configured for receiving sales transaction information, said processor being programmed to provide the following functionality;
a series of control functions that can be selectively activated by user input to the at least one processor for creating at least one subset of the sales transaction information, wherein the series of control functions includes at least one of a product-type control, a time period-type control, a predetermined grouping of customers, and a predetermined market;
a plurality of graphical representations that are generated based on the selected subset of sales transaction information, wherein the plurality of graphical representations includes at least one or more of a graphical representation of gross sales price information minus predetermined cost elements versus quantity, a slope and scatter diagram of sales transaction information, a price and margin solver, a time series chart, a price sensor, a margin sensor and a break-even analysis graph, waterfall analysis of sales transaction information, a low volume analysis tool for estimating opportunity of moving low margin products to average margins of comparable products, a single customer analysis tool for determining value with a single customer, and a transactional waterfall bubble chart, wherein the processor includes at least one electronic display for displaying at least one of said graphical representations.

36. A method for processing and displaying selected sales transaction information comprising:
receiving sales transaction information with at least one processor;
selectively activating a series of control functions programmed into said at least one processor, by user input to the at least one processor, for creating at least one subset of the sales transaction information;
generating a plurality of graphical representations based on the selected subset of sales transaction information; and
displaying at least one of said graphical representations on at least one electronic display.

37. The method for processing and displaying selected sales transaction information according to claim 36 wherein the series of control functions includes:
at least one regional-type control selected from the group consisting of at least one predetermined sales organization, at least one predetermined geographic region, at least one predetermined country where products are shipped, or at least one sales representative;
at least one product-type control selected from the group consisting of predetermined product information, a subgrouping of a predetermined product, a component for a predetermined product component, a different version of a predetermined product, a different category of a predetermined product, or a predetermined material handling group for a predetermined product; and
at least one time period-type control selected from the group consisting of a predetermined quarter, a predetermined month or a predetermined year.

38. The method for processing and displaying selected sales transaction information according to claim 36, wherein the series of control functions includes at least one of predetermined grouping of customers, a predetermined market and a predetermined submarket.

39. The method for processing and displaying selected sales transaction information according to claim 36, wherein the plurality of graphical representations includes at least one a graphical representation of gross sales price information minus predetermined cost elements versus quantity.

40. The method for processing and displaying selected sales transaction information according to claim 36, wherein the at least one graphical representation of gross sales price information minus predetermined cost elements versus quantity is graphically presented with fishtail analysis.

41. The method for processing and displaying selected sales transaction information according to claim 36, wherein the plurality of graphical representations includes at least one of a slope and scatter diagram of sales transaction information selected from the group consisting of a target price, an invoice gross, a first imputed discount, a sales order price, a top quartile price, a second imputed discount, a small quantity upcharge, discounts printed on an invoice, invoice net, volume rebate, transactional corrections, allocated corrections, early payment discount(s), net price, variable cost of raw materials, packaging cost, last leg of freight charges, variable margin, net price, cash cost of accounts receivables, cash cost of inventory, internal shipment cost, cost to serve, commissions, duties, pocket margin, fixed costs, energy costs or profit margin versus quantity.

42. The method for processing and displaying selected sales transaction information according to claim 41, further comprising utilizing at least one of a waterfall chart, a series chart, and a logarithmic graph.

43. The method for processing and displaying selected sales transaction information according to claim 36, further comprising estimating at least one of a price element, a margin element and a cost element with a price and margin solver.

44. The method for processing and displaying selected sales transaction information according to claim 36, wherein the plurality of graphical representations includes at least one of a time series chart, a price sensor, a margin sensor and a break-even analysis graph.

45. The method for processing and displaying selected sales transaction information according to claim 44, wherein the price sensor includes a first portion that is a price decrease of a predetermined percentage or more and a second portion that is a price change of the predetermined percentage or less and a third portion that is a price increase of the predetermined percentage and the margin sensor includes a first portion that is a margin decrease of a predetermined percentage or more and a second portion that is a margin change of the predetermined percentage or less and a third portion that is a margin increase of the predetermined percentage.

46. The method for processing and displaying selected sales transaction information according to claim 36, wherein the plurality of graphical representations includes at least one waterfall analysis of sales transaction information selected from the group consisting of a target price, an invoice gross, a first imputed discount, a sales order price, a top quartile price, a second imputed discount, a small quantity upcharge, discounts printed on an invoice, invoice net, volume rebate, transactional corrections, allocated corrections, early payment discount(s), net price, variable cost of raw materials, packaging cost, last leg of freight charges, variable margin, net price, cash cost of accounts receivables, cash cost of inventory, internal shipment costs, cost to serve, commissions, duties, pocket margin, fixed costs, energy costs or profit margin versus quantity.

47. The method for processing and displaying selected sales transaction information according to claim 36, further comprising estimating opportunity of moving low margin products to average margins of comparable products, which generates a graphical representation of sales and at least one of profit margin and pocket margin over predetermined time periods with a low volume analysis tool.

46. The method for processing and displaying selected sales transaction information according to claim 35, further comprising determining value with a single customer, which generates a graphical representation of least one of profit margin and pocket margin and at least one of percentage of quantity and percentage of sales over predetermined percentages of customer dependence with a single customer analysis tool.

47. The method for processing and displaying selected sales transaction information according to claim 35, further comprising utilizing a transactional waterfall bubble chart that shows at least one of invoice gross, net price, target price, and top quartile price in relationship to at least one of a target price, an invoice gross, a first imputed discount, a second imputed discount, a small quantity upcharge, discounts printed on an invoice, volume rebate, transactional corrections, allocated corrections, early payment discount(s), variable cost of raw materials, packaging costs, last leg of freight charges, variable margin, cash cost of accounts receivables, cash cost of inventory, internal shipment costs, cost to serve, commissions, duties, pocket margin, fixed costs, energy costs and profit margin.

48. A method for processing and displaying selected sales transaction information comprising:
receiving sales transaction information with at least one processor;
selectively activating a series of control functions programmed into said at least one processor, by user input to the at least one processor, for creating at least one subset of the sales transaction information, wherein the series of control functions includes at least one of a product-type control, a time period-type control, a predetermined grouping of customers, and a predetermined market;
generating a plurality of graphical representations based on the selected subset of sales transaction information wherein the plurality of graphical representations includes graphical representation of at least one of gross sales price information minus predetermined cost elements versus quantity, a slope and scatter diagram of sales transaction information, a price and margin solver, a time series chart, a price sensor, a margin sensor and a break-even analysis graph, waterfall analysis of sales transaction information, a low volume analysis tool for estimating opportunity of moving low margin products to average margins of comparable products, a single customer analysis tool for determining value with a single customer, and a transactional waterfall bubble chart; and
displaying at least one of said graphical representations on at least one electronic display.
